(19) United States
(12) Patent Application Publication
(10) Pub. No.: US 2008/0284642 A1
(43) Pub. Date: Nov. 20, 2008

(54) OPTIMIZING BANDWIDTH OF A GLOBAL POSITIONING SYSTEM

(75) Inventors: Lisa Anne Seacat, San Francisco, CA (US); Timothy R. Chavez, Austin, TX (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/750,238

(22) Filed: May 17, 2007

(51) Int. Cl. G01S 1/00

(52) U.S. Cl. 342/357.1; 342/357.06

(57) ABSTRACT

A method and system for optimizing a global positioning system. In one embodiment, the method includes receiving an indication of at least one change in coordinate attributes, determining a plurality of cost and transaction rules based on at least one user preference, and processing a plurality coordinate transactions based on the least one cost and transaction rule.

### FIELD OF THE INVENTION

The present invention relates to navigation systems, and more particularly to a method and system for optimizing bandwidth of a global positioning system.

### BACKGROUND OF THE INVENTION

A global positioning system (GPS) is a satellite-based navigation system that includes a constellation of multiple Earth-orbiting satellites. The term GPS is often used to refer to a GPS receiver, which is a hand-held device that operates to locate several satellites, to determine the distances between the GPS receiver and the located satellites, and to compute the geographic location of the GPS receiver based on those distances.

The GPS receiver receives signals from the located satellites. Such signals may include, for example, coordinates, current date, current time, etc. These transactions typically occur constantly to enable the GPS receiver to maintain current location information.

What is needed is a method and system for optimizing a global positioning system. The present invention addresses such a need.

### SUMMARY OF THE INVENTION

A method and system for optimizing global positioning systems are disclosed. In one embodiment, the method includes receiving an indication of at least one change in coordinate attributes. The coordinate attributes include at least one current geographic location, at least one current time, at least one current position relative to at least one second geographic location, at least one past geographic position, at least one time associated with the past geographic position, at least one current orientation, at least one past orientation, at least one current speed, and at least one past speed. The method also includes determining a plurality of cost and transaction rules based on at least one user preference. At least one cost and transaction rule controls a type of coordinate transaction. At least one cost and transaction rule controls how often to process coordinate transactions. At least one cost and transaction rule is a monetary-based rule that limits the number of coordinate transactions to as few transactions as possible in order to reduce costs. The plurality of cost and transaction rules is based on user-defined preferences. The method also includes processing a plurality coordinate transactions based on the least one cost and transaction rule. The plurality of coordinate transactions comprises sending and receiving coordinate information. Coordinate information comprises at least one current GPS coordinate, at least one predictive GPS coordinate, and at least one coordinate attribute. The method also includes converting a plurality of GPS coordinates into animation for display on a screen. The converting is based on a tuple of coordinate attributes. As a result, coordinate transactions are processed in an efficient and cost effective manner.

### BRIEF DESCRIPTION OF THE DRAWINGS

FIG. 1 is a block diagram of a global positioning system (GPS) in accordance with one embodiment of the present invention.

FIG. 2 is a flow chart showing a method for optimizing a GPS in accordance with one embodiment of the present invention.

### DETAILED DESCRIPTION OF THE INVENTION

The present invention relates to global positioning systems, and more particularly to a method and system for optimizing bandwidth of global positioning systems. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A system and method in accordance with the present invention for optimizing a global positioning system are disclosed. The method includes receiving an indication of at least one change in coordinate attributes. Coordinate attributes may include a current geographic location, a current time, a past geographic position, a speed, etc. The method also includes determining one or more cost and transaction rules based on at least one user preference. Cost and transaction rules control the type of coordinate transaction, how often to process coordinate transactions, and may be monetary-based rules that limit the number of coordinate transactions to as few transactions as possible in order to reduce costs. The method also includes processing a coordinate transactions based on the least one cost and transaction rule. Embodiments optimize the bandwidth of a GPS by sending data in fewer and fuller packets based on the needs and preferences of a user, which may include money constraints. As a result, coordinate transactions are processed in an efficient and cost effective manner. To more particularly describe the features of the present invention, refer now to the following description in conjunction with the accompanying figures.

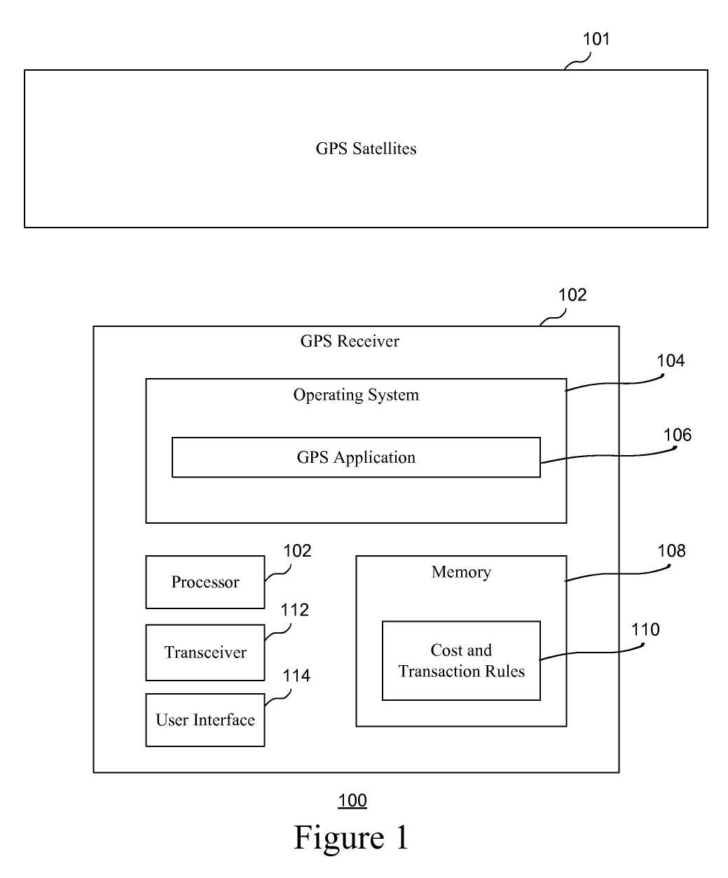

FIG. 1 is a block diagram of a global positioning system (GPS) 100 in accordance with one embodiment of the present invention. As FIG. 1 shows, the GPS 100 includes multiple satellites 101 and a GPS receiver 102 that is operable to locate several (e.g., four or more) satellites. The GPS receiver 102 includes a processor 102, an operating system 104 having a GPS application 106, a memory 108 that stores cost and transaction rules 110, a transceiver for sending and receiving GPS data such as coordinates, and a user interface 114.

In operation generally, the GPS application 106 of the GPS receiver 102 functions to determine the distance of the GPS receiver 102 to each located GPS satellite 100 and uses an algorithm to determine the geographic location of the GPS receiver 102 based on those distances. In particular embodiments, the algorithm may utilize triangulation to compute the location.

A user may then use the GPS receiver 102 to know the user's geographic location via the user interface 114, which typically displays a map and other information such the user's/GPS receiver's position on the map, as well as other information such as longitude, latitude, landmarks, etc. In some embodiments, the GPS receiver 102 may include wireless data mechanisms to process, transmit, receive, and display data. Such data may include, for example, cellular text messages and data transmitted via Internet services. In one embodiment, the GPS system 100 may send the GPS receiver 102 an initial packet of information that indicates a map scale and possibly other information such as a map version. This ensures that the GPS receiver 102 is using the same map as other GPS receivers. In particular embodiments, the GPS receiver 102 may send GPS coordinates to other systems or store GPS coordinates in the memory 108, in an external memory, or in a database for future use.

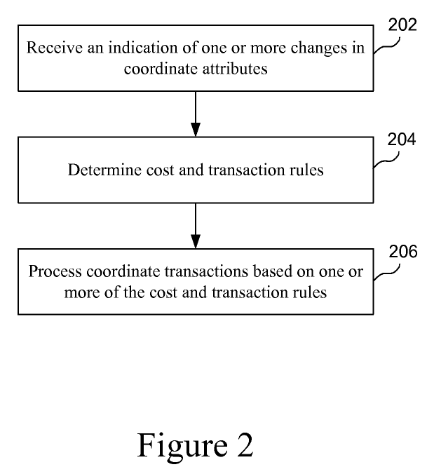

FIG. 2 is a flow chart showing a method for optimizing a GPS in accordance with one embodiment of the present invention. Referring to both FIGS. 1 and 2, the process begins in step 202 where the GPS receives an indication of one or more changes in coordinate attributes. An indication may include, for example, a change in location, a change is speed, etc. Next, in step 204, the GPS application 106 determines the cost and transaction rules based on one or more preferences of a user. In one embodiment, the GPS application 106 may define a relationship between cost and one or more transactions. For example, a cost may be associated with each transaction or with a group of transactions, where the cost may be in terms of money, time, etc. The GPS application 106 may apply cost and transaction rules to control the timing of the transactions, and thus control costs.

As described in more detail below, in particular embodiments, the cost and transaction rules may include rules for limiting the number of transactions in a given time period. For example, the rules may limit the number of transactions per second, minute, per hour, per day, etc. In one embodiment, the cost and transaction rules may be user-defined or user-selected if provided by a GPS service provider.

Next, in step 206, the GPS application 106 processes coordinate transactions based on one or more of the cost and transaction rules. In one embodiment, the GPS application 106 may determine if and when to process the coordinate transactions, where a coordinate transaction may involve sending or receiving coordinate information. In particular embodiments, coordinate information may include current GPS coordinates, predictive GPS coordinates, coordinate attributes, etc.

In one embodiment, the GPS application 106 may immediately send out coordinates. This scenario may occur if, for example, a given transaction limit has not been reached or set. In one embodiment, the GPS application 106 may not send out GPS coordinates at all. This scenario may occur if, for example, a given transaction limit has been reached.

In one embodiment, the GPS application 106 may store the GPS coordinates in the memory 108 and send out the coordinates in a cluster of GPS coordinates at a future time. In particular embodiments, when the GPS application 106 sends out GPS coordinates, the GPS application 106 may send out the GPS coordinates with a set of predictive GPS coordinates.

In one embodiment, predictive GPS coordinates may involve a group of coordinates being sent to a device, rather than just one GPS coordinate. For instance, to give the appearance of up-to-date coordinates, messages may be sent intermittently with multiple coordinates in temporal order. If a user has specified a destination on the user's GPS receiver 106 and if the user is following a particular path, the GPS application 106 may then send coordinates in the future indicating where the user highly probable to be located before the next message of coordinates is sent. The coordinates may be sent directly to a device or through a service depending on the implementation.

In one embodiment, the GPS application 106 may compute predictive GPS coordinates that are based on coordinate attributes. In one embodiment, coordinate attributes may include a current geographic location, a current time, a current position relative to another geographic location (e.g., landmark), past geographic positions and times associated with the past geographic positions, current and past orientation, current and past speed/velocity, etc. Based on a given set of coordinate attributes, the GPS application 106 is operable to predict future locations and times. For example, if the GPS application 106 determines that a vehicle (transporting the GPS receiver 102) is heading towards an intersection at a given speed, the GPS application 106 may assume that the vehicle will slow down or stop (based on known elements such as known stop signs or known traffic signals). Note that for ease of illustration, reference to coordinate attributes associated with a vehicle are used interchangeably with reference to coordinate attributes associated with the GPS receiver 102. It is assumed for illustrative purposes that the vehicle is transporting the GPS receiver 102. The GPS application may compute when and where the vehicle will stop and for how long based on the presence of a stop sign or traffic signal. The GPS application may compute a decrease in velocity at a given point and may predict the speed of the vehicle at the intersection based on an absence of a stop sign or traffic signal.

Because the GPS application 106 may not know which direction the vehicle may change directions, accelerate, or decelerate, computations may be based at least in part on updates to the coordinate attributes. Computations may also be based at least in part on knowledge of the driver (e.g., whether the driver is likely following a path recommended by the GPS application).

In one embodiment, cost and transaction rules may control the type of coordinate transaction. For example, the GPS application 106 may compute or re-compute a speed position if the vehicle has slowed down considerably (e.g., measurement of inertia) or has stopped, but may or may not transmit a periodic geographic location, because such a transaction may not be needed.

In one embodiment, the cost and transaction rules may control how often to process coordinate transactions. For example, the accuracy of the predictive GPS coordinates may vary depending on the current coordinate attributes. For example, the predictive GPS coordinates may be more predictive if the vehicle is traveling on a freeway at a constant speed. When the vehicle is stopped, no transmissions are necessary. As the vehicle travels faster, the GPS application 106 may process coordinate transactions more frequently in order to more accurately pinpoint the location of the GPS receiver 102.

In one embodiment, the GPS application 106 may convert the computed GPS coordinates and/or predictive GPS coordinates (e.g., velocity) into animation for display on a screen (e.g., on the user interface 114). In one embodiment, the GPS application 106 may convert the computed GPS coordinates and predictive GPS coordinates based on a tuple of coordinate attributes such as (x, y, S) where S is the speed (e.g., rate of change between this coordinate and the next). As such, if the vehicle is traveling 60 MPH, the GPS application 106 may compute the distance between two locations x and y to be 1 mile. The GPS application 106 also compute that it would take 1 minute to get from one location x to the next location y. In particular embodiments, the GPS application 106 may scale the GPS coordinates and/or GPS predictive coordinates to a map and determine how to animate and provide directions.

In one embodiment, the GPS application 106 may associate a priority to a set of coordinates. For example, the user or GPS service provider may have a queue of GPS coordinates, where a transaction involving a higher-priority GPS set of coordinates occurs immediately and the coordinate attributes (e.g., location, speed, etc.) are immediately displayed to the user. In one embodiment, a cost and transaction rule may assign a high priority to GPS coordinates associated with unpredictable or sudden changes in coordinate attributes (e.g., direction, increases in speed, reductions of speed, etc.). As such, predictive GPS coordinates may be more beneficial for places with long stretches of road where direction and speed are not likely to change.

In one embodiment, the GPS application 106 may apply monetary-based rules to limit the number of coordinate transactions to as few transactions as possible in order to reduce costs. This is particularly beneficial when a user is paying per transaction.

In one embodiment, the cost and transaction rules may be based on user-defined preferences or user-selected preferences provided by a GPS provider. For example, the user may define or select how much money and/or airtime minutes the user is willing to spend in a given allotted time period (e.g., per day/month/year, etc.). Based on these preferences, the GPS application 106 may send or receive coordinates to satisfy the user preferences (e.g., user's budget).

In one embodiment, some cost and transaction rules may be applied based on monetary considerations, the predictive coordinates, or a combination thereof.

According to the system and method disclosed herein, the present invention provides numerous benefits. For example, embodiments of the present invention enable a user to control the number of transactions that the GPS receiver performs based on the cost and transaction rules. By controlling the number of transactions, embodiments of the present invention may enable a user to also stay within a predefined budget.

A system and method in accordance with the present invention for optimizing bandwidth of a global positioning system has been disclosed. The method includes receiving an indication of at least one change in coordinate attributes, determining cost and transaction rules based on at least one user preference, and processing coordinate transactions based on at least one cost and transaction rule.

The present invention has been described in accordance with the embodiments shown. One of ordinary skill in the art will readily recognize that there could be variations to the embodiments, and that any variations would be within the spirit and scope of the present invention. For example, embodiments of the present invention may be implemented using hardware, software, a computer-readable medium containing program instructions, or a combination thereof. Software written according to the present invention or results of the present invention may be stored in some form of computer-readable medium such as memory, hard drive, CD-ROM, DVD, or other media for subsequent purposes such as being executed or processed by a processor, being displayed to a user, etc. Also, software written according to the present invention or results of the present invention may be transmitted in a signal over a network. In some embodiments, a computer-readable medium may include a computer-readable signal that may be transmitted over a network. Accordingly, many modifications may be made by one of ordinary skill in the art without departing from the spirit and scope of the appended claims.

What is claimed is:

1. A method for use in a global positioning system, the method comprising:
receiving an indication of at least one change in coordinate attributes, wherein the coordinate attributes comprise at least one current geographic location, at least one current time, at least one current position relative to at least one second geographic location, at least one past geographic position, at least one time associated with the past geographic position, at least one current orientation, at least one past orientation, at least one current speed, and at least one past speed;
determining a plurality of cost and transaction rules based on at least one user preference, wherein the least one cost and transaction rule controls a type of coordinate transaction, wherein at least one cost and transaction rule controls how often to process coordinate transactions, wherein at least one cost and transaction rule is a monetary-based rule that limits the number of coordinate transactions to as few transactions as possible in order to reduce costs, and wherein the plurality of cost and transaction rules are based on user-defined preferences; and
processing a plurality coordinate transactions based on the least one cost and transaction rule, wherein the plurality of coordinate transactions comprise sending and receiving coordinate information, wherein coordinate information comprises at least one current GPS coordinate, at least one predictive GPS coordinate, and at least one coordinate attribute; and
converting a plurality of GPS coordinates into animation for display on a screen, wherein the converting is based on a tuple of coordinate attributes.

2. The method of claim 1 further comprising:
storing GPS coordinates in a memory; and
sending the GPS coordinates in a cluster of GPS coordinates at a future time.

3. The method of claim 1 further comprising one or more of processing, transmitting, receiving, and displaying data that comprises cellular text messages and data transmitted via Internet services.

4. A global positioning system (GPS) comprising:
a GPS application that computes a plurality of coordinate attributes based on a plurality of transaction rules;
a processor that executes the GPS application; and
a memory coupled to the processor, wherein the memory stores the plurality of transaction rules, wherein the GPS application is operable to:
receive an indication of at least one change in coordinate attributes, wherein the coordinate attributes comprise at least one current geographic location, at least one current time, at least one current position relative to at least one second geographic location, at least one past geographic position, at least one time associated with the past geographic position, at least one current orientation, at least one past orientation, at least one current speed, and at least one past speed;
determine a plurality of cost and transaction rules based on at least one user preference, wherein the least one cost and transaction rule controls a type of coordinate transaction, wherein at least one cost and transaction rule controls how often to process coordinate transactions, wherein at least one cost and transaction rule is a monetary-based rule that limits the number of coordinate transactions to as few transactions as possible in order to reduce costs, and wherein the plurality of cost and transaction rules are based on user-defined preferences; and
process a plurality coordinate transactions based on the least one cost and transaction rule, wherein the plurality of coordinate transactions comprise sending and receiving coordinate information, wherein coordinate information comprises at least one current GPS coordinate, at least one predictive GPS coordinate, and at least one coordinate attribute; and
convert a plurality of GPS coordinates into animation for display on a screen, wherein the converting is based on a tuple of coordinate attributes.

5. The system of claim 4 wherein the GPS application is further operable to:
store GPS coordinates in the memory; and
send the GPS coordinates in a cluster of GPS coordinates at a future time.
